(19) United States
(12) Patent Application Publication
(10) Pub. No.: US 2018/0001608 A1
(43) Pub. Date: Jan. 4, 2018

(54) PYLON SNAP JACKET ENCASEMENT

(71) Applicants: Mark Porter, Jacksonville, FL (US); Stafford McCartney, Green Cove Springs, FL (US); Derek Michael Porter, Jacksonville, FL (US)

(72) Inventors: Mark Porter, Jacksonville, FL (US); Stafford McCartney, Green Cove Springs, FL (US); Derek Michael Porter, Jacksonville, FL (US)

(73) Assignee: Shoreline Plastics LLC, Jacksonville, FL (US)

(21) Appl. No.: 15/595,899

(22) Filed: May 15, 2017

Related U.S. Application Data
(63) Continuation of application No. 14/746,912, filed on Jun. 23, 2015.
Application No. 14/746,912 is a continuation-in-part of application No. 14/312,663, filed on Jun. 23, 2014.
(60) Provisional application No. 62/336,171, filed on May 13, 2016.

(51) Int. Cl. B32B 27/30; B32B 27/20; B32B 27/32; B29C 47/88; B32B 1/08; B32B 7/12; B32B 15/08; B29C 47/90; B32B 21/08; B32B 27/06; B32B 27/08; B29C 63/42; B29C 47/00; B29C 47/34; B29C 71/02; B29K 27/06; B29K 105/00; B29K 105/02; B29L 23/00

(52) U.S. Cl. CPC B32B 27/304; B29C 47/0057; B32B 27/20; B32B 27/302; B32B 27/306; B32B 27/308; B32B 27/32; B29C 47/0023; B29C 47/882; B32B 1/08; B29C 47/8865; B32B 7/12; B32B 15/08; B29C 47/90; B32B 21/08; B32B 27/06; B32B 27/08; B29C 47/908; B29C 63/42; B29C 47/0064; B29C 47/0092; B29C 47/009; B29C 47/34; B29C 47/8805; B29C 47/881; B29C 47/8835; B29C 47/889; B29C 47/8895; B29C 47/902; B29C 47/903; B29C 47/904; B29C 2071/022; B29C 2791/007; B29K 2027/06; B29K 2105/0097; B29K 2105/02; B29L 2023/22; B32B 2307/58; B32B 2307/7145; B32B 2307/736; B32B 2597/00; B32B 2419/00

(57) ABSTRACT

The present invention provides a protective coating for protecting a substrate from deleterious elements present in environments in which the substrates are deployed and methods and apparatus for deploying a PVC encasement with a longitudinal snap jacket of suitable length and girth to coat a pylon substrate or building girder and provide a filler within the snap jacket and around an encased pylon.

### CROSS-REFERENCE TO RELATED APPLICATION

This This application claims the benefit of U.S. Provisional Patent Application Ser. No. 62/336,171 filed May 13, 2016, and entitled “PYLON ENCASEMENT WITH LONGITUDINAL SPLIT COLLAR”; and also claims priority as a continuation in part to U.S. Non-Provisional patent application Ser. No. 14/746,912, filed Jun. 23, 2015, and entitled “SUBSTRATE WITH PROTECTIVE POLYVINYL CHLORIDE SLEEVE” which in turn is a Continuation in Part of application Ser. No. 14/312,663, filed Jun. 23, 2014, and entitled “EXTRUDED HEAT SHRINK PROTECTIVE SEAMLESS PVC PILING SLEEVE AND METHOD”, the entire contents of which are incorporated herein by reference.

### FIELD OF THE INVENTION

The present invention relates generally to methods and apparatus for repairing pylons. More specifically, the present invention provides methods and apparatus for a manufacturing and deploying protective polyvinyl chloride encasement with a longitudinal snap jacket over a pylon substrate and filling an interstitial space with cement or other filler forming a resultant protected pylon substrate.

### BACKGROUND

Wood pylons and timbers used in marine applications have been subjected for centuries to the costly problem of marine growth and wood boring infestation. Similar problems plague terrestrial structures. Generally protection for such structures from the detrimental effect of harmful organisms is limited to surface treatments or impregnating the wood with chemical solutions to inhibit the attachment of the various infestations. However, pylons and other structures deteriorate quickly when exposed to the elements and adverse infestation.

Repair of pylons and other structures often requires disassembly of the structure and removal of deteriorated support structures and replacement of the structures with new structures. Even cement and steel structures are subject to deterioration and subsequent replacement.

### SUMMARY OF THE INVENTION

Accordingly, the present invention provides a snap jacket encasement for surrounding a perimeter of a support structure, such as a pylon and filling with a replacement material, such as cement and/or aggregate to provide a protective coating and thereby protecting the support structure from deleterious elements present in environments in which the support structures are deployed. The present disclosure also provides methods and apparatus for manufacturing snap jacket encasement of suitable length and girth to encase a pylon substrate, building girder or other substrate. More specifically, in some embodiments, the present invention provides an environmentally friendly and robust protective coating for encasing and protecting a structural substrate with a cross section of generally eight inches or greater in diameter, and in preferred embodiments a diameter of twelve inches or greater; or an angular shaped substrate with a diagonal cross section of generally eight inches or greater and preferred embodiments a diagonal of twelve inches or greater.

The present invention also includes methods and apparatus for securing a snap jacket with an open collar on a protective sleeve into a snap jacket with a closed collar forming a protective sleeve and manufacturing a sleeve of protective coating with a snap jacket closed collar. In some embodiments, multiple protective sleeves may be joined along a longitudinal seam to provide a larger diameter of protective coating.

As discussed more fully below, in some exemplary implementations of the present invention, a continuously extruded seamless polyvinyl chloride (“PVC”) sleeve may be manufactured from a combination of a unique PVC compound and a specialized extrusion process which enables the extruded sleeve to be further processed to form an open longitudinal collar that may be fastened into a closed longitudinal collar.

In some aspects of the present invention, a manufactured open collar PVC sleeve can be positioned surrounding a substrate, such as a wooden beam for a pylon, or other timber, tie, column or dimensional lumber by opening the longitudinal collar and inserting the substrate into an interior of the open collar PVC sleeve. The open collar PVC sleeve may then be closed and fastened thereby providing a robust closed collar encasement around the substrate without removing the substrate from its deployed state within a structure.

A flowable mixture may be deposited into the interior of the closed collar encasement. The flowable mixture will preferably form to a shape defined by an exterior surface of the substrate and an interior surface of the closed collar encasement. The flowable mixture preferably includes a material that will cure, polymerize or set to form a solid material which, combined with the encased substrate acts as a refurbished support structure. In some preferred embodiments, the flowable mixture will include cement and one or more of aggregate, fibers, rebar, additives or other beneficial component.

The closed collar encasement and seamless impervious membrane will generally protect the substrate from environmental conditions and offset the ability of an internal wood boring or surface destroying organism to negatively interact with the wooden substrate. In some embodiments, the substrate being encapsulated can be of suitable length for building materials, pylons, tapering or parallel, treated or untreated with a diameter of between about 4 inches up to about 60 inches or more, based in part upon post processing of the extruded PVC (or other material) encasement which allows the encasement to be conjoined along a longitudinal seam.

Another aspect of the present invention includes methods of protecting a structure substrate (e.g., a wood pylon, utility pole, traffic barrier, building support or dimensional lumber or other wood or metal structure) according to principles of the invention including encasing at least a portion of the substrate in a longitudinally closed collar encasement sleeve. Preferably an area between the substrate and the longitudinally closed collar encasement sleeve is backfilled with a flowable mixture which subsequently sets to provide further mechanical stability to the structure of which the substrate is a part of.

According to the present invention, a closed collar encasement sleeve may include a blend melt including PVC and a fungicide or other additive mixture. The melt is extruded through a die to form a seamless PVC sleeve having an outer surface, an inner surface and an unexpanded inner diameter greater than about four inches. In addition, the extruded seamless PVC sleeve includes a longitudinal feature that may be machined or otherwise processed into a closable longitudinal collar that is included in a longitudinally closed collar encasement.

After installation, one or both of the substrate encased with the longitudinally closed collar encasement may be deployed for use or further fitted with endcaps, such as PVC endcaps.

### BRIEF DESCRIPTION OF THE DRAWINGS

The foregoing and other aspects, objects, features and advantages of the invention will become better understood with reference to the following description, appended claims, and accompanying drawings, where:

FIG. 1 illustrates a snap jacket with a longitudinal collar that may be snapped closed.

FIG. 2 illustrates a pylon substrate with a snap jacket encasement and a cement filler.

FIG. 3 illustrates a snap jacket encasement with a variable length insert.

FIG. 4 illustrates a pylon with a snap jacket encasement and filler deployed in all environment including submersion in water.

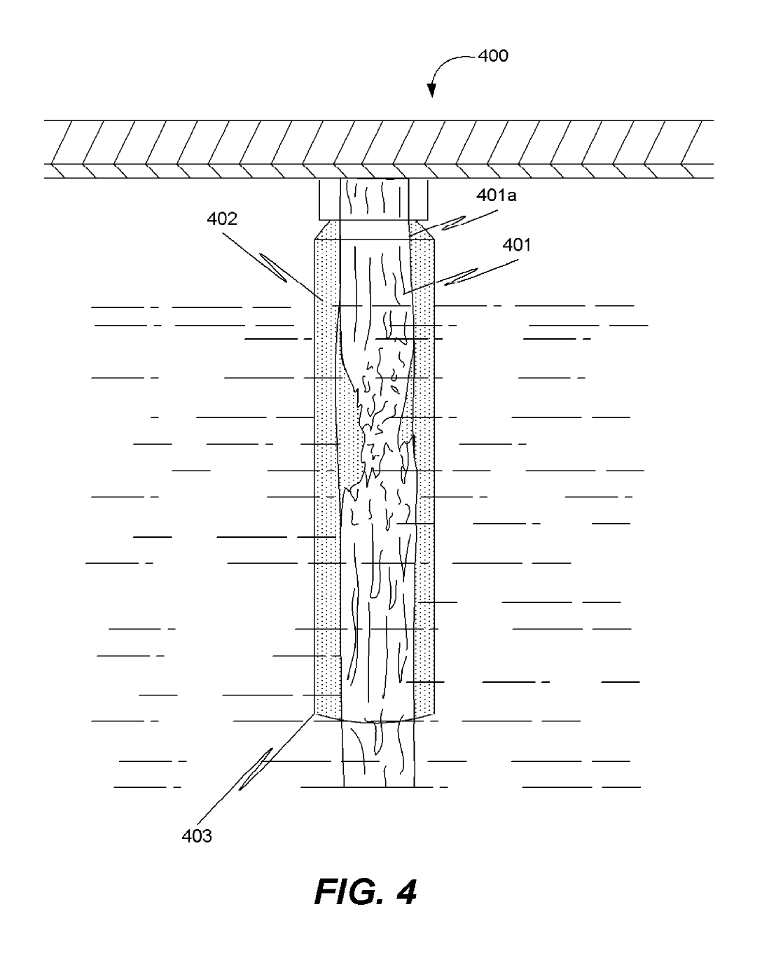

FIG. 5 illustrates a cut-away of a pylon and snap jacket encasement with filler.

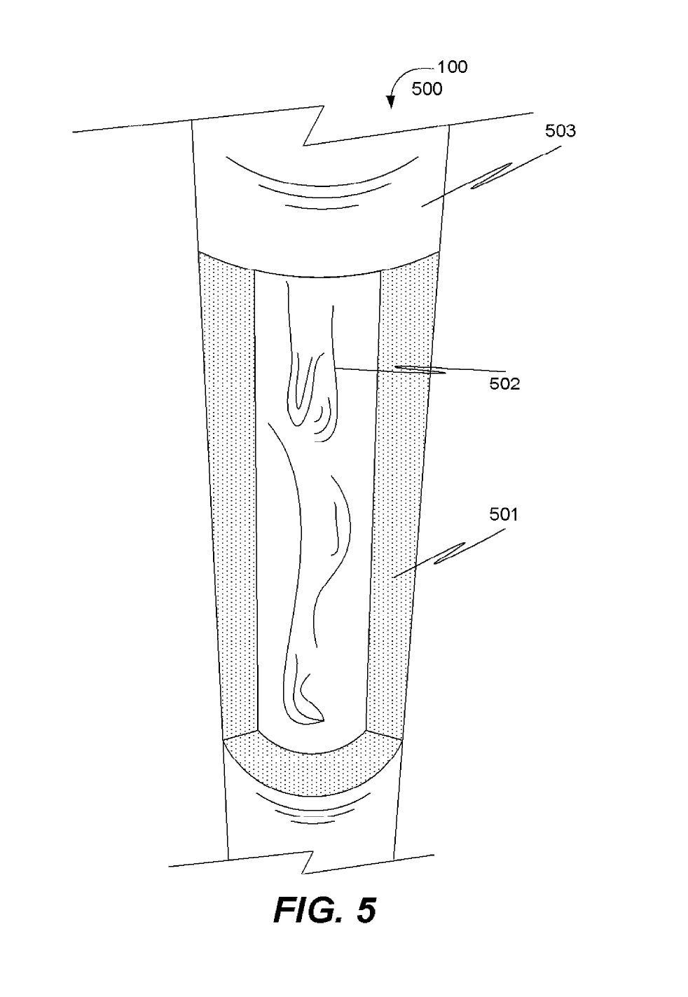

FIG. 6 illustrates pylons that may be treated with a snap jacket encasement and filler.

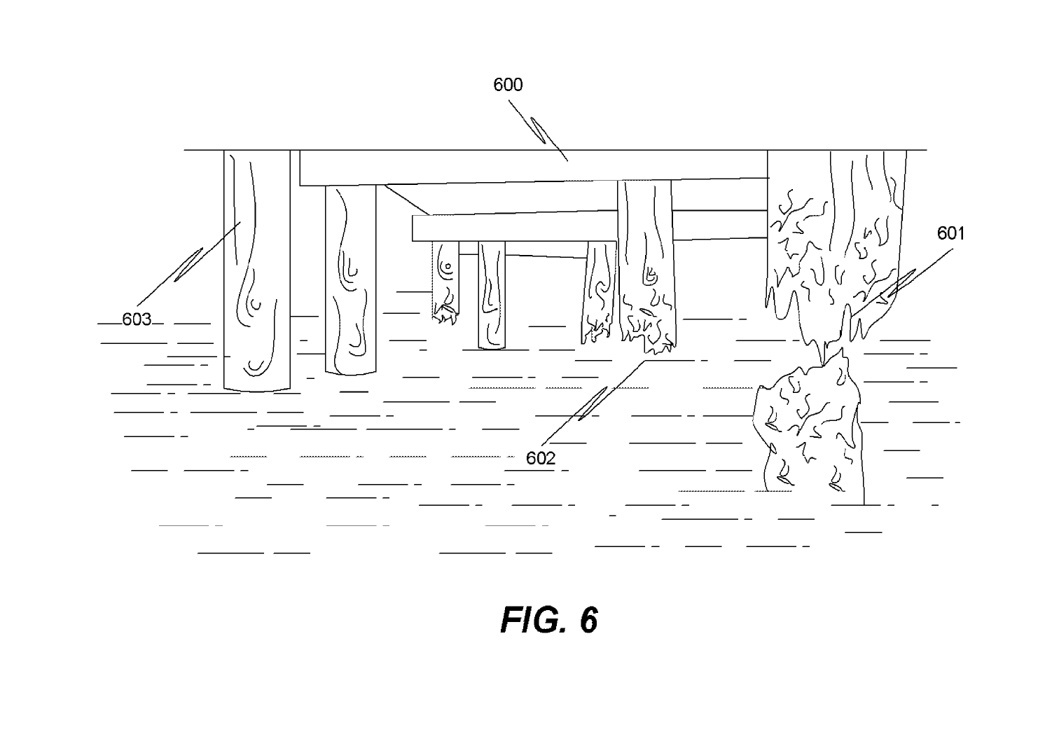

FIG. 7 illustrates a worker removing a section of a pylon that may subsequently be encased with a snap jacket encasement.

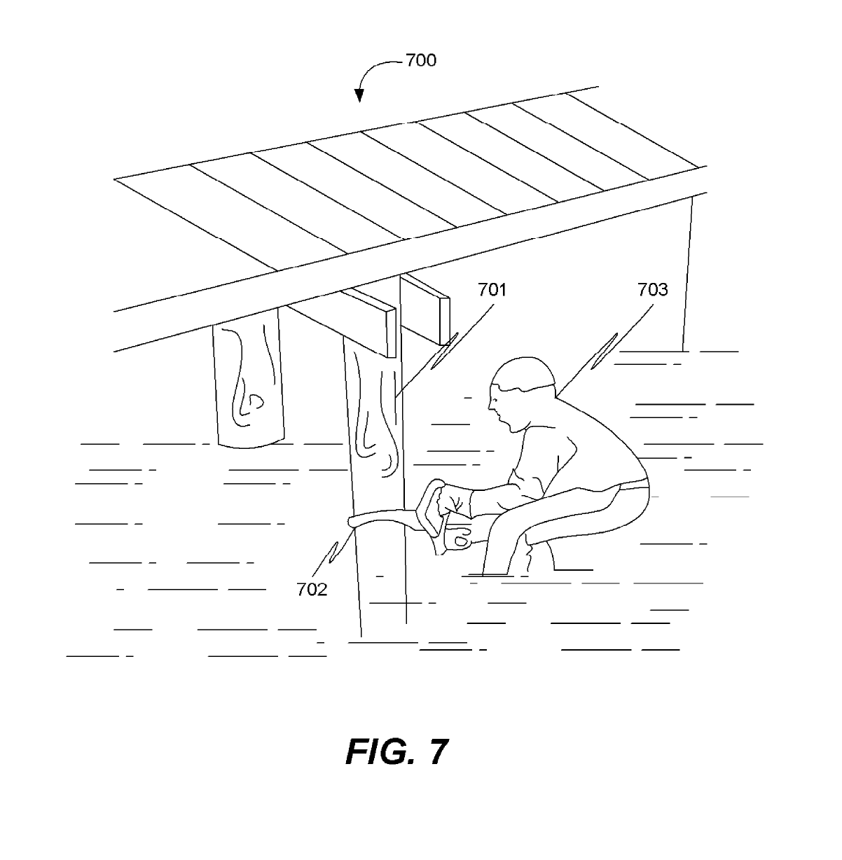

FIG. 8 illustrates pylons with sections removed.

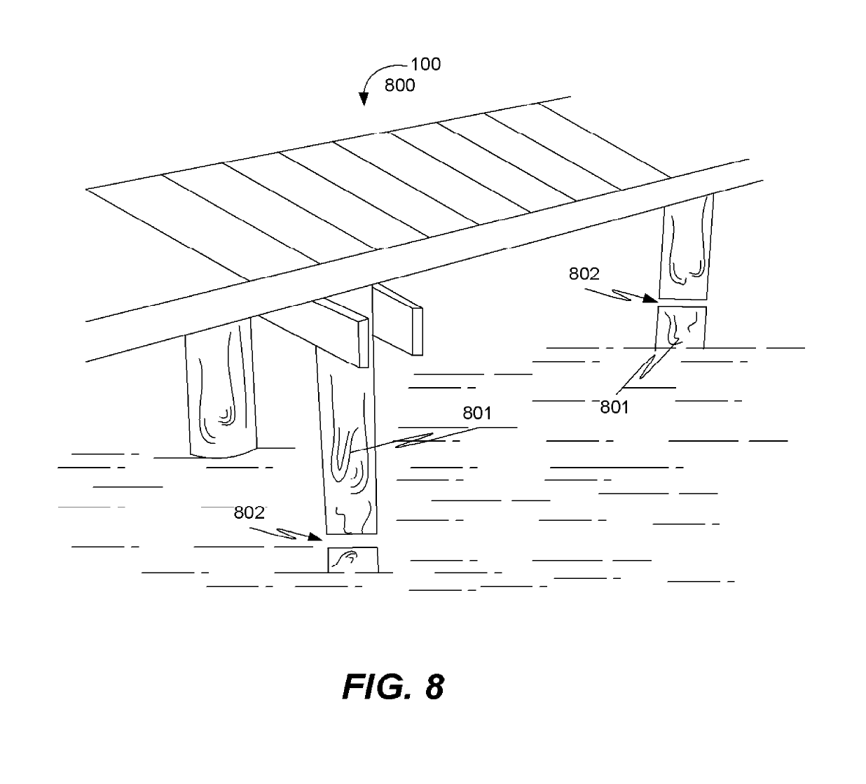

FIG. 9 illustrates a worker installing a snap jacket encasement on a pylon with a section of the pylon removed.

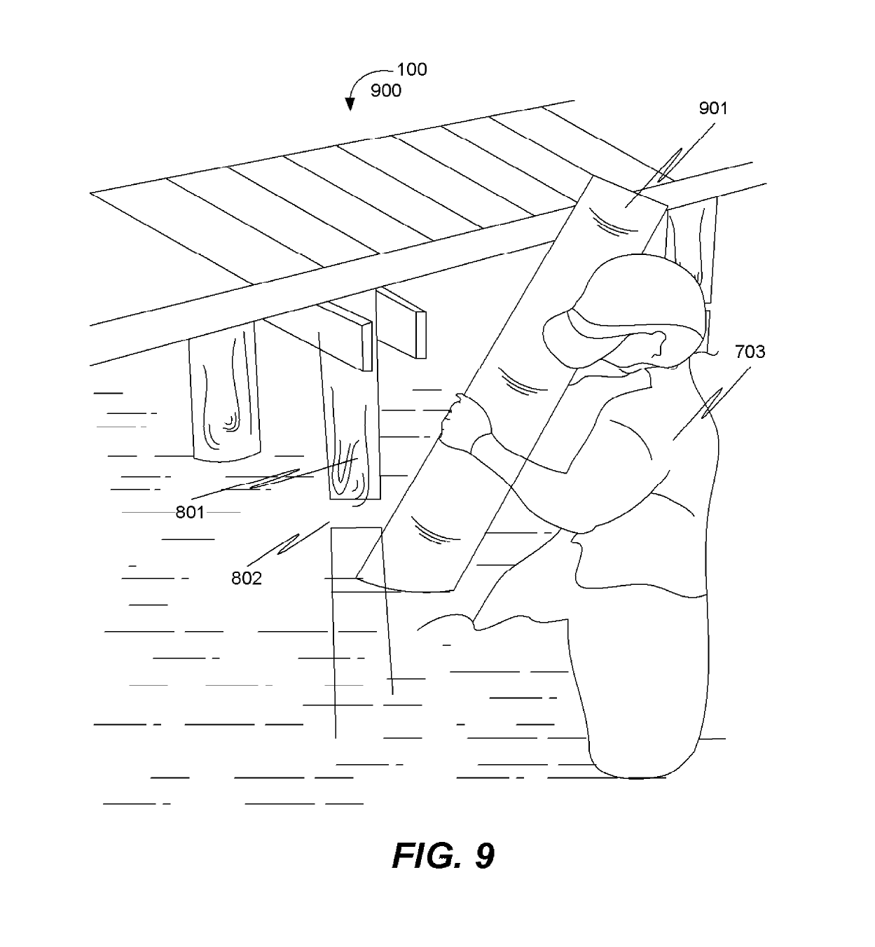

FIG. 10 illustrates a pylon with a snap jacket encasement installed around the pylon.

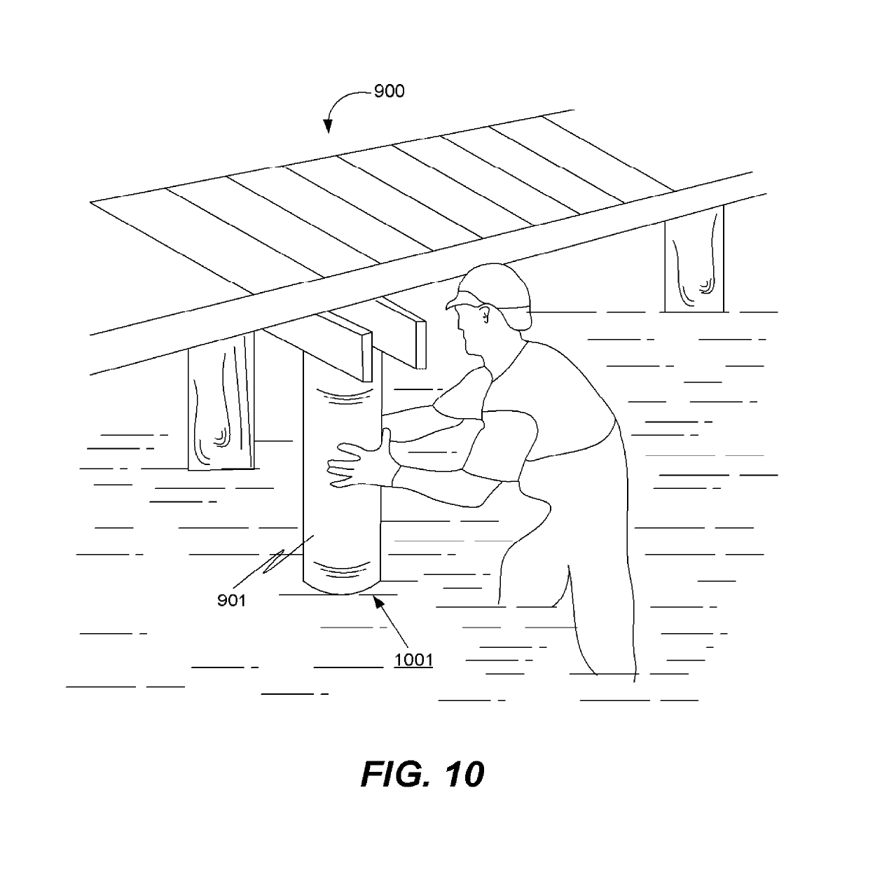

FIG. 11 illustrates a worker installing a snap jacket over a pylon partially submerged in water.

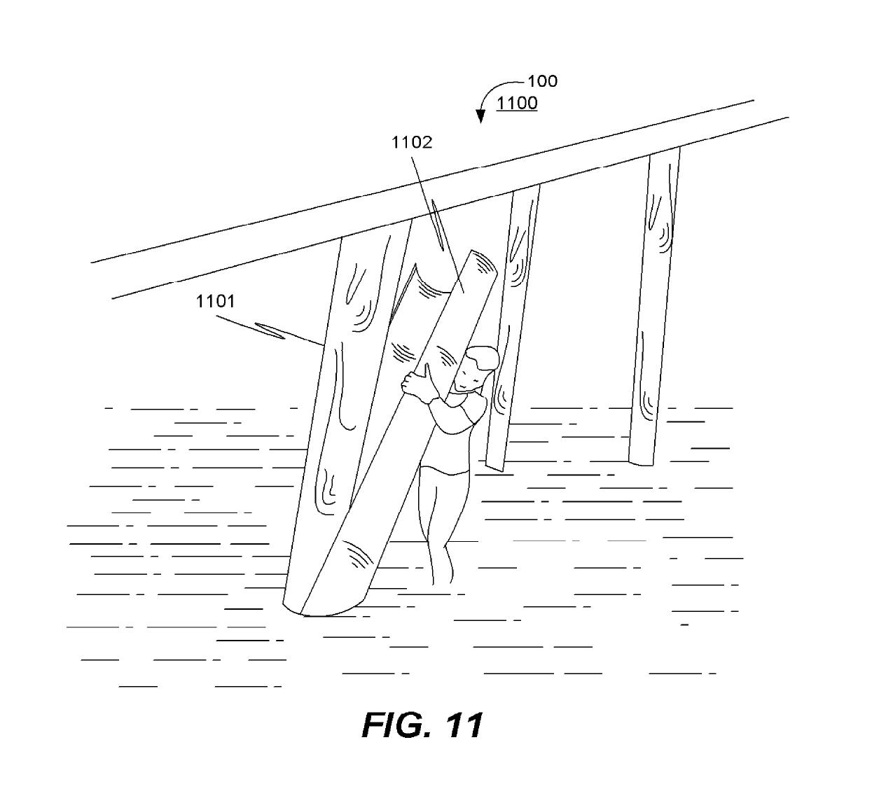

FIG. 12 illustrates a series of snap jacket encased pylons with end caps installed.

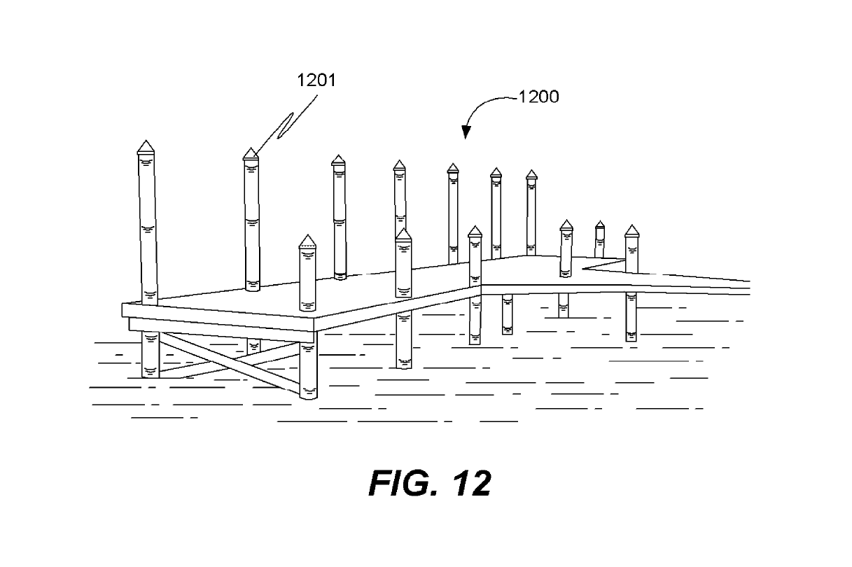

FIG. 13 illustrates a pylon with a snap jacket receiving a filler within the snap jacket and around the pylon.

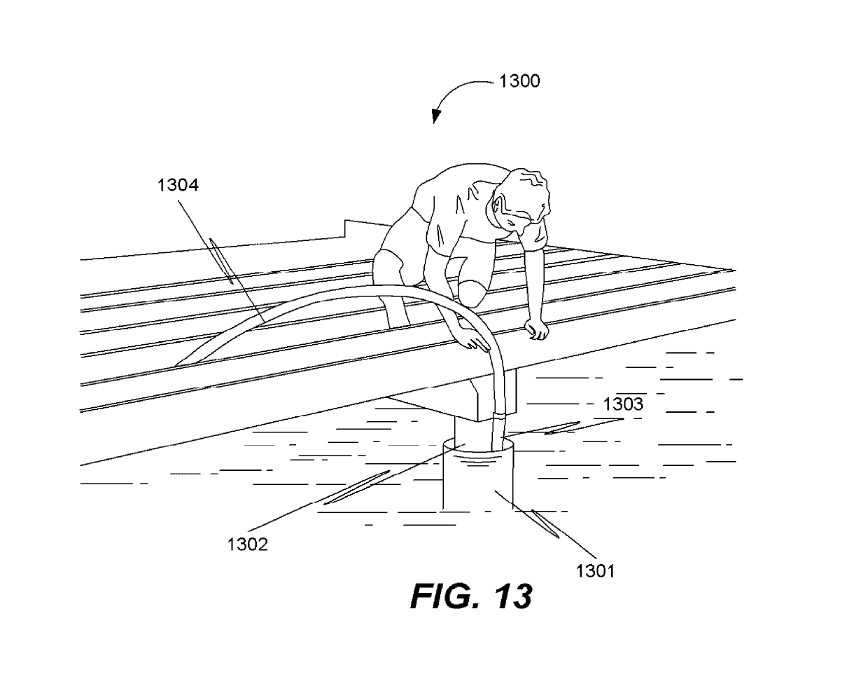

FIG. 14 illustrates a pylon encased with a snap jacket and including a longitudinal seam formed by the snapped joint.

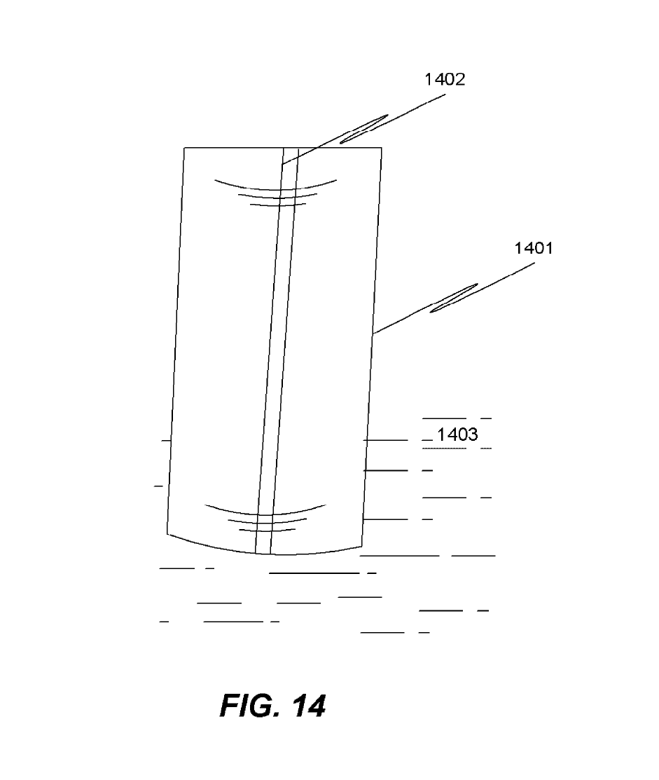

FIG. 15 illustrates a structure with multiple snap jacket encased pylons.

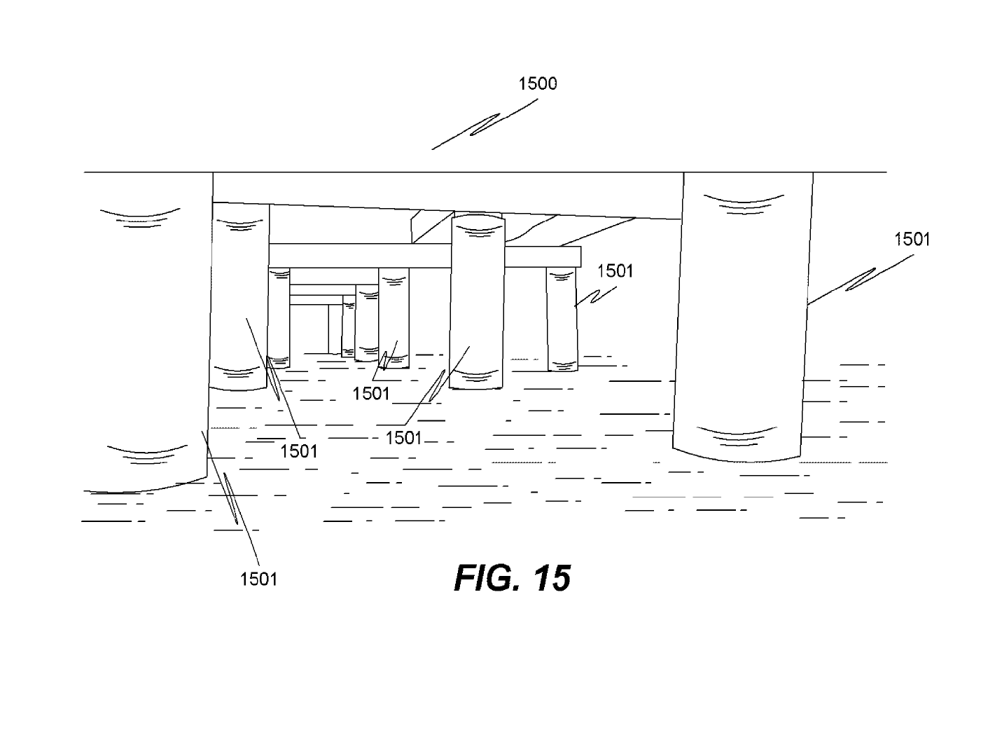

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

The present invention provides for a pylon (or other substrate) with longitudinally snap jacket encasement. The longitudinally snap jacket encasement is functional to protect the pylon from exposure to deleterious elements present in environments in which the substrates may be deployed. The present invention also includes methods and apparatus for manufacturing the longitudinally snap jacket encasement in the form of a PVC sleeve of suitable length and diameter to encapsulate a pylon size or larger substrate, such as for example a wooden pylon, a bridge support, a timber, a traffic post, building or other structure support, or other large substrate exposed to a hostile environment and subject to deterioration.

More specifically, the present invention provides a PVC longitudinally snap jacket encasement to protect a curvilinear or other shaped substrate, which may in some preferred embodiments be four inches or greater in diameter or an angular shaped substrate four inches with a diagonal of twelve inches or greater, and also include a substrate of twelve inches or greater in diameter or an angular shaped substrate twelve inches with a diagonal of fourteen inches or greater and methods and apparatus for manufacturing said PVC longitudinally snap jacket encasement. In some embodiments an end cap may also be deployed to further encapsulate the substrate or girder.

To solve one or more of the problems set forth above, in some exemplary implementations of the present invention, a continuously extruded seamless polyvinyl chloride (“PVC”) pipe is manufactured from a combination of a unique PVC compound and a specialized extrusion process is provided that enables the PVC sleeve to be processed, such as via machining to form the longitudinal snap jacket seam after the PVC is extruded.

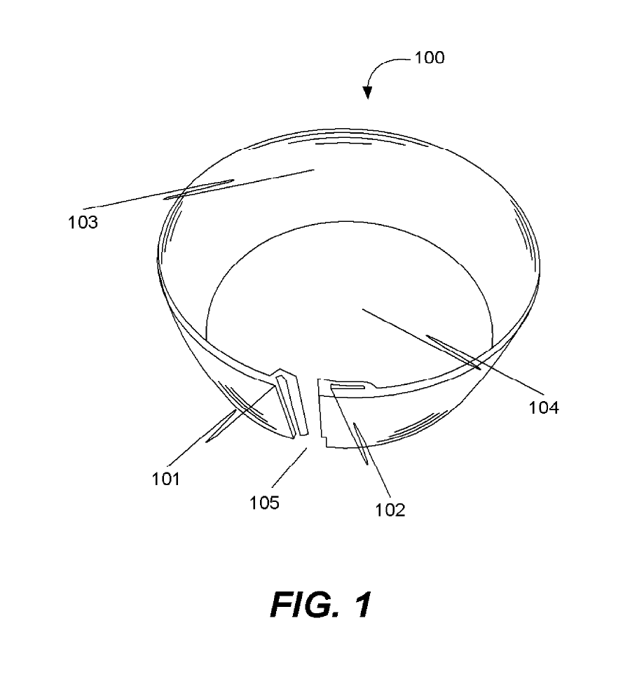

Referring now to FIG. 1, the present invention includes snap jacket encasement sleeve 100 with an interior surface 103 forming an enclosed area 104 suitable in size and shape for encasing a pylon. The snap jacket includes a longitudinal snap 105 with a first longitudinal edge portion 101 and a second longitudinal edge portion 102 forming a closable interface for fixedly joining the first edge portion 101 to the second edge portion 102. The snap jacket may include a PVC sleeve with a formed edge.

In some preferred embodiments, the snap jacket encasement sleeve 100 may be formed with raw materials comprising a dry blend of plastic polyvinyl chloride pellets and additional optional ingredients are introduced through a hopper and extruded into a pipe with a longitudinal enclosable seam sometimes referred to herein as a “PVC sleeve”, in various embodiments, additional components may be included in the PVC blend and various designs of longitudinal sleeve may be extruded. In some specific embodiments a longitudinal seam will be extruded in a single form and longitudinally cut to form a snappable interface.

A dry blend PVC compound to be extruded into snap jacket encasement may include components to both reflect and absorb ultra-violet rays, coloring pigments, process stabilizers, flexibility enhancers, surface migrating ablative fungicides/biocides and algaecides. A non-limiting example of an exemplary blend is provided below in Table 1.

It is understood that various blends may in include all or some subset of the following listed components:

TABLE 1

| Parts* | Wt % | Material | Lbs |
|---|---|---|---|
| 100 | 78.25% | PVC Resin | 460.00 |
| 4 | 3.13% | Ultra-Violet Inhibitor | 18.40 |
| 5 | 3.91% | UFT Calcium Carbonate | 23.00 |
| 0.8 | 0.63% | Calcium Stearate | 3.68 |
| 1.2 | 0.94% | Paraffin Wax | 5.52 |
| 0.2 | 0.16% | Oxidized Polyethylene | 0.92 |
| 7 | 5.48% | Plasticizer | 32.20 |
| 0.02 | 0.02% | Marine Growth Inhibitor | 0.09 |
| 1.2 | 0.94% | Heat Stabilizer | 5.52 |
| 4 | 3.13% | Process Aid | 18.40 |
| 0.38 | 0.30% | Grey Color | 1.75 |
| 3 | 2.35% | Epoxidized Soy Bean Oil | 13.80 |
| 1 | 0.78% | Ultra-Violet Absorbative | 4.60 |
| 127.8 | 100.0% | TOTALS | 587.88 |

*Parts by weight per 100 parts of PVC resin

A motor may power one or more screws of an extruder. The extruder heats the raw material supplied through a hopper and forces the resulting melted polymer through an extrusion die. The molten polymer leaves the extruder die 10 in the form of one or more ribbons or molten streams.

The extrusion die supports and distributes the homogeneous polymer melt around a solid mandrel, which forms the homogeneous polymer melt into an annular shape resembling a solid wall sleeve. The formed solid wall pipe is sometimes referred to herein as a “sleeve.” In some preferred embodiments, following extrusion, the formed pipe is seamless, though it may exhibit artifacts from the extrusion process and also includes a longitudinal formation that may be further processed such, as via machining or sawing to create a longitudinal snap jacket.

In some exemplary embodiments, the longitudinal formation that is further processed to create a longitudinal snap jacket may include two longitudinal features at a distance between each other of about ½ inch or more.

The PVC sleeve is not limited to a structure having a circular cross section. Structures having non-circular cross section shapes (e.g., rectangular) may be produced in accordance with the principles of the invention. Thus, for examples, pipes having rectangular cross section shapes may encapsulate lumber and ties having rectangular cross section shapes. Additionally, pipes having shapes that differ from the shape of the substrate (e.g., a circular cross section pipe over a rectangular cross section substrate) may encapsulate the substrate.

Pullers may be used to provide necessary forces to pull the PVC sleeve through post extrusion processing and maintain a proper wall thickness by providing a constant pulling rate. A first puller may control the wall thickness of the pre-expanded pipe and prevent a second puller from influencing a thickness of the PVC sleeve as it is drawn from a die. Increasing the puller speed at a constant screw speed may reduce the wall thickness, while reducing the puller speed at the same screw speed may increase wall thickness. The two pullers may be electronically controlled and linked to precisely control the wall thickness of the expanded pipe.

The pipe is then cut by a cutter 160 into specified lengths for bundling, storage and shipping. The pipe may be cut into any desired lengths (e.g., 8, 10, 12, or 16 feet). Lengths that are not greater than 40 to 50 feet can be shipped easily by rail or truck. Bundling provides ease of handling and safety during loading and unloading.

The extrusion line may have one or more printing stations for printing notations on the pipe. An on-line gauging system may measure the product's outer diameter with a laser-based scantier. Such laser gauging systems have a very high measurement accuracy and a very high scanning rate for measurement averaging. Such gauging scanners are usually placed in the extrusion line after cooling and before the belt puller.

The PVC longitudinally snap jacket encasement is opened at the collar and fitted around the pylon. The sleeve does not have to cover the entire pylon. The portion of the pylon below the seabed does not have to be covered. The portion of the pylon consistently above the sea level does not have to be covered. The remaining portion of the pylon should be covered. As the sleeve diameter is greater than the pylon diameter, the sleeve should freely slide on the pylon.

Following extrusion, the PVC longitudinally snap jacket encasement may be post processed, such as, via reheating along a longitudinally area in order to make the PVC longitudinally snap jacket encasement more flexible and able to be opened more easily. In some embodiments, reheating may also provide increased strength to the PVC longitudinally snap jacket encasement.

In another aspect, the PVC longitudinally snap jacket encasements may be nested for shipment which allows for less volume during shipping and also provides for combined increased modulus allowing for greater ease of handling.

After the sleeve is correctly positioned over the portions of the pylon to be protected, the collar is fastened closed thereby creating an encasement around the substrate. Closure may be facilitated with a strap wrench, hose clamp, winch, or other tool for facilitating mechanical movement towards a smaller diameter during the closure process.

In still another aspect, in some embodiments, a seam resulting from a fastened longitudinal snap jacket, may be further sealed with a sealant, such as a silicone or other curable substance to provide further protection against seepage of water or other liquid through the seam.

The encasement may be filled with a flowable substance, such as a cement mixture, an aggregate, a polymer, an insulator, a foam, an epoxy mixture or other desirable substance. IN some specific embodiments a fire retardant material, such as vermiculite may be included in the flowable material to provide protection against files. Such embodiments may be especially effective for utility poles that are periodically exposed to situations that may result in fire. Other applications include support structures for buildings, and in particular as a method and apparatus for providing increased protection against explosions that damage building infrastructure, such as structures in underground parking lots in multi-level buildings. Other embodiments may include providing an encasement around piping, such as, for example around natural gas or water piping,

In preferred embodiments, the flowable mixture will conform to the shape of the surface of the encased substrate and the inner surface of the closed PVC longitudinally snap jacket encasement. The resulting product is a pylon with a longitudinally closed PVC snap jacket encasement covering at least a portion of the pylon.

A fungicide may be included in one or both of the PVC dry blend and the hot melt adhesive. Any fungicide suitable for extrusion processing and marine applications may be utilized within the scope of the present invention. Alternatively, a fungicide coating may be applied to the surfaces of the pipe after manufacturing.

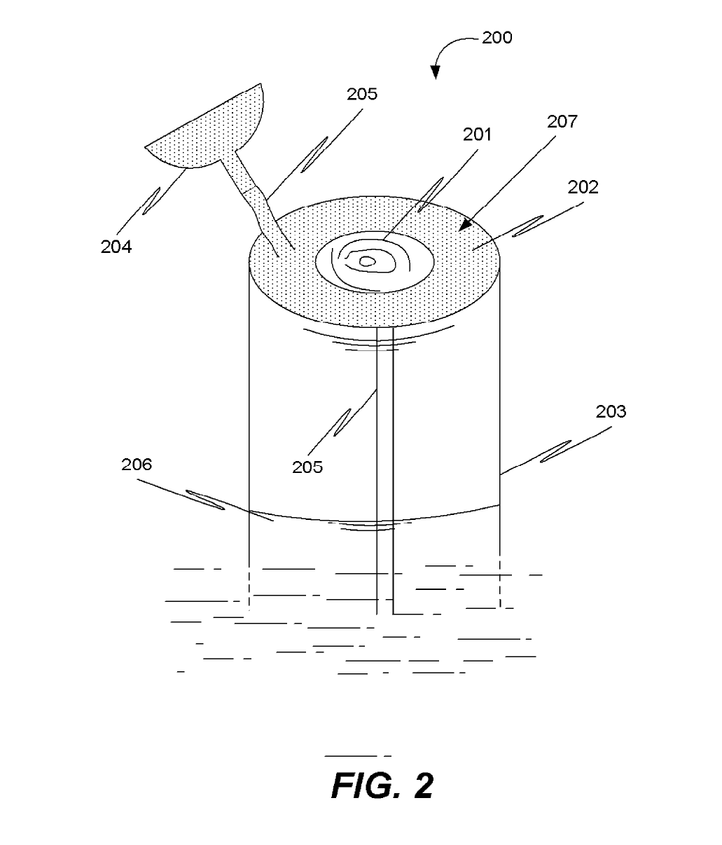

As illustrated in FIG. 2, a cross section illustrating some aspects of the present invention as embodied in a generally round PVC encasement 203 with a longitudinal collar 205. The longitudinal collar 105 may be engaged to create a fixed closure of the PVC encasement 203. In the interior of the PVC encasement 207, a flowable material 202, such as cement, cement with aggregate or other additive, or a polymer may be included. In addition, in some embodiments an optional material preservative and/or fungicide or other material may be contained within the PVC encasement 203 enclosure and flowable material 202. A substrate 201 is encased by the PVC encasement 203.

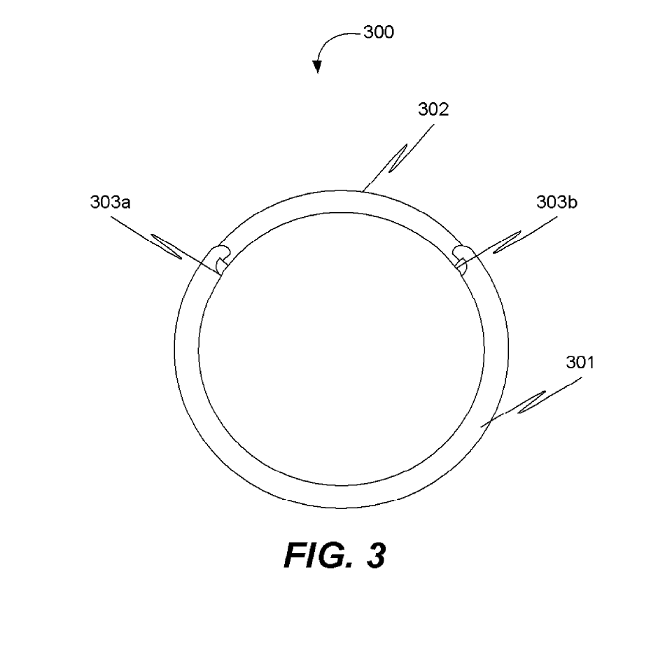

Referring now to FIG. 3, in some embodiments, two or more longitudinal snap jacket portions 301-302 may be interlocked to create a single multi-part encasement 300 of a greater diameter. For example a PVC encasement 300 with an 18 inch diameter may be formed via assembly of a first longitudinal snap jacket 301 interlocked with a second longitudinal snap jacket 302 from a second PVC encasement of a same or different diameter, such as for example a second diameter of 24 inches, which will result in a single encasement with a diameter equal to the diameter of the combined PVC encasements (i.e. 42 inches). The multiple PVC encasements 301 and 302 may be joined along longitudinal snap seams 303a-303b.

The PVC encasement may include a generally angular square cross section or a curvilinear cross section. A snap jacket may be fastened to secure the PVC encasement and flowable material. The angular cross section is shown concentrically with a volume of flowable material, such as cement that may cure into a solid form with added mechanical strength to the pylon or other substrate. Accordingly, implementations of the present invention may include a substrate including a wooden pylon with a diameter of any given cross section of between about six inches and fourteen inches. Similarly, implementations may include a timber beam with an angular shape such as a square or a rectangle, with each side of the timber beam between about six inches and twelve inches,

Substrates to be protected by the pipe may include wood pylon, dimensional lumber, railroad ties, fence posts, elongated metal structures such as steel beams, columns and posts, and the like. Any elongated structure having a diameter or maximum width that is less than the inner diameter or width of the pipe may be protected by the pipe. The pipe does not have to cover the entirety of the substrate. Rather, only the portion requiring protection may be covered. In some cases, the entirety of the substrate may require protection. In other cases, only a portion (e.g., a submerged portion) may require protection.

The pipe is not limited to a circular cross section. Other shapes, including but not limited to rectangular, I-beam, L, U, and other curvaceous or polygonal shapes may be produced within the scope of the invention.

In another aspect, in some implementations of the present invention, during installation of PVC longitudinally snap jacket encasements, an area around a base of a pylon may be cleared of soil, muck and debris up to a depth of 12 inches or more. Clearing may be accomplished via blowing the area around the base. The pylon may also be cleaned, such as, via power washing.

In still other implementations, it may be beneficial to remove a portion of a pylon or other substrate and replace a section of the pylon with an insert. The insert may be held in place via pressure from the downward pressure of the pylon top section, or secured via convention methods, such as a bracket and bolts. The PVC encasement with a longitudinal snap jacket may surround the pylon and the insert, and the cement of other flowable mixture will hold the insert and pylon in place relative to each other.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of providing a pylon substrate with a longitudinal snap jacket protective encasement, said method comprising steps of:
opening the longitudinal snap jacket encasement wide enough to insert the pylon substrate within an interior of the longitudinal snap jacket encasement;
securing the snap jacket in a closed position; and
pouring a flowable mixture into an area bordered by the longitudinal snap jacket encasement.

2. A longitudinal snap jacket encasement system comprising:
a PVC encasement with a longitudinal snap jacket around a pylon substrate with the snap jacket fastened in a closed position; and
a flowable mixture poured in between the pylon substrate and the PVC encasement with a longitudinal snap jacket.
